(19) United States
(12) Patent Application Publication
(10) Pub. No.: US 2025/0175097 A1
(43) Pub. Date: May 29, 2025

(54) TRIBO-COMPOSITION FOR TRIBOELECTRIC NANOGENERATOR AND TRIBOELECTRIC NANOGENERATOR INCLUDING SAME

(71) Applicant: KOREA UNIVERSITY OF TECHNOLOGY AND EDUCATION INDUSTRY-UNIVERSITY COOPERATION FOUNDATION, Cheonan-si (KR)

(72) Inventors: Jin Woo BAE, Seoul (KR); Seung-Ju OH, Cheonan-si (KR); Jae Uk YOON, Yongin-si (KR); Prasad GAJULA, Cheonan-si (KR); In Sun WOO, Cheongju-si (KR)

(73) Assignee: KOREA UNIVERSITY OF TECHNOLOGY AND EDUCATION INDUSTRY-UNIVERSITY COOPERATION FOUNDATION, Cheonan-si (KR)

(21) Appl. No.: 18/586,480

(22) Filed: Feb. 25, 2024

Related U.S. Application Data
(63) Continuation of application No. PCT/KR2023/020955, filed on Dec. 19, 2023.

(30) Foreign Application Priority Data
Nov. 23, 2023 (KR) 10-2023-0164276
Nov. 23, 2023 (KR) 10-2023-0164312
Dec. 4, 2023 (KR) 10-2023-0173288
Dec. 4, 2023 (KR) 10-2023-0173339

(51) Int. Cl. H02N 1/04

(52) U.S. Cl. CPC H02N 1/04

(57) ABSTRACT

A tribo-composition for a triboelectric nanogenerator includes a triboelectric nanogenerator in which a tribo-positive electrode composition including a graphene oxide-based nanomaterial is applied as a tribo-positive electrode layer, or a triboelectric nanogenerator in which a tribo-negative electrode composition including any one among fluorine-functionalized graphite, a perovskite material, and molybdenum sulfide (MoS₂) is applied as a tribo-negative electrode layer.

### CROSS REFERENCE TO RELATED APPLICATIONS

This application is a Continuation of PCT International Patent Application No. PCT/KR2023/020955 filed on Dec. 19, 2023, which claims priority to Korean Patent Application Nos. 10-2023-0164312 filed on Nov. 23, 2023, 10-2023-0164276 filed on Nov. 23, 2023, 10-2023-0173288 filed on Dec. 4, 2023 and 10-2023-0173339 filed on Dec. 4, 2023 which are all hereby incorporated by reference in their entirety.

### BACKGROUND OF THE INVENTION

The present invention relates to a tribo-composition for a triboelectric nanogenerator and a triboelectric nanogenerator including the same. One embodiment includes a triboelectric nanogenerator in which a tribo-positive electrode composition including a graphene oxide-based nanomaterial is applied as a tribo-positive electrode layer. In addition, one embodiment includes a triboelectric nanogenerator in which a tribo-negative electrode composition including any one among fluorine-functionalized graphite, a perovskite material, and molybdenum sulfide (MoS₂) is applied as a tribo-negative electrode layer.

The present invention is the result of research conducted with the support of the National Research Foundation of Korea's ‘Application to Next-Generation High-Transparency High-Stretch Sensor and Electrochemical Display Device Using Non-Aqueous-based High-Performance Multi-functional Ionic Conductive, Non-Ionic Conductive Polymer Gel' project (No. 1711190086) with the funding of the government (Ministry of Trade, Industry and Energy) from Mar. 1, 2021 to Feb. 19, 2024 and the Korea Planning & Evaluation of Industrial Technology's the ‘Preparation of Piezoelectric Fluorine-based Copolymer Resin and Development of Utilization Technology’ project (No. 1415185197) with the funding of the government (Ministry of Trade, Industry and Energy) from Apr. 1, 2021 to Dec. 31, 2024.

A triboelectric nanogenerator (TENG) is a device that generates electrical energy by utilizing static electricity generated when two different materials come into contact or rub against each other. A triboelectric nanogenerator is less harmful to the environment than traditional power generation methods, is environmentally friendly because it operates on renewable energy sources, and can be applied to a variety of application fields because it can be made in small sizes, which is why many studies are being conducted on the triboelectric nanogenerator. Such a triboelectric nanogenerator can be applied to biosensors, electricity supply to implantable or extracorporeally-attachable devices, continuous power generation using human movement, and the like.

However, a triboelectric nanogenerator currently faces technical limitations such as low power density and high internal impedance. In order to overcome the above-described limitations, a tribo-composition with high electromechanical conversion efficiency should be applied.

A relevant prior art document is the Korean Patent Laid-Open Publication No. 10-2023-0134367.

### SUMMARY OF THE INVENTION

The present invention is to provide a tribo-composition for a triboelectric nanogenerator having high power density and low impedance and a triboelectric nanogenerator including the tribo-composition for a triboelectric nanogenerator.

In addition, the present invention has high sensitivity.

In addition, the present invention has high mechanical stability and durability.

In addition, the present invention has excellent efficiency even at a low pressure.

In addition, the present invention has excellent sensitivity, and thus, may use various sources as a power generation source.

A tribo-positive electrode composition for a triboelectric nanogenerator according to an embodiment of the present invention includes reduced graphene oxide-tetraethylenepentamine (rGO-TEPA), and a first polymer.

The content of the reduced graphene oxide-tetraethylenepentamine may be 1 part by weight to 10 parts by weight based on 100 parts by weight of the first polymer.

A tribo-negative electrode composition for a triboelectric nanogenerator according to an embodiment of the present invention includes any one among fluorine-functionalized graphite, a perovskite material, and molybdenum sulfide (MoS₂), and a second polymer.

The content of the fluorine-functionalized graphite may be 5 parts by weight to 15 parts by weight based on 100 parts by weight of the second polymer, the content of the perovskite material may be 5 parts by weight to 10 parts by weight based on 100 parts by weight of the second polymer, and the content of the molybdenum sulfide may be 0.2 parts by weight to 2.0 parts by weight based on 100 parts by weight of the second polymer. The perovskite material may be barium strontium titanate.

A triboelectric nanogenerator according to an embodiment of the present invention includes a tribo-positive electrode layer and a tribo-negative electrode layer.

The tribo-positive electrode layer may include reduced graphene oxide-tetraethylenepentamine (rGO-TEPA) and a first polymer, and the tribo-negative electrode layer may include any one among fluorine-functionalized graphite, a perovskite material, and molybdenum sulfide (MoS2), and a second polymer.

The tribo-positive electrode layer may be prepared by an electrospinning method using a first mixture in which the reduced graphene oxide-tetraethylenepentamine and the first polymer are mixed.

The tribo-negative electrode layer may be prepared by a casting method using a second mixture in which any one among the fluorine-functionalized graphite, the perovskite material, and the molybdenum sulfide (MoS₂), and the second polymer are mixed.

A tribo-composition for a triboelectric nanogenerator and a triboelectric nanogenerator including the tribo-composition for a triboelectric nanogenerator according to an embodiment of the present invention have high power density and low impedance.

In addition, the present invention has high sensitivity.

In addition, the present invention has high mechanical stability and durability.

In addition, the present invention has excellent efficiency even at a low pressure.

In addition, the present invention has excellent sensitivity, and thus, may use various sources as a power generation source.

### BRIEF DESCRIPTION OF THE DRAWINGS

FIG. 1 is a conceptual diagram of a triboelectric nanogenerator according to an embodiment of the present invention.

FIG. 2 shows SEM photographs of reduced graphene oxide-tetraethylenepentamine, Positive electrode Comparative Example 1, and Positive electrode Examples 1 to 4.

FIG. 3 shows XRD analysis results of Positive electrode Comparative Example 1, reduced graphene oxide-tetraethylenepentamine, and Positive electrode Example 4.

FIG. 4 is an SEM photograph of Negative electrode Example 3.

FIG. 5 is an EDS result photograph of Negative electrode Example 3.

FIG. 6 shows XRD analysis results of silicone rubber, fluorine-functionalized graphite, and Negative electrode Example 3.

FIG. 7 shows dielectric constant and dielectric loss measurement results for Negative electrode Examples 1 to 3 and Negative electrode Comparative Example 1.

FIG. 8 shows surface potential measurement results over time for Negative electrode Examples 1 to 3 and Negative electrode Comparative Example 1.

FIG. 9 shows SEM photographs (a) and (b) of Negative electrode Examples 5 and 7.

FIG. 10 shows XRD analysis results of Negative electrode Examples 5 to 7 and Negative electrode Comparative Example 2.

FIG. 11 shows dielectric constant and dielectric loss measurement results for Negative electrode Examples 5 to 7 and Negative electrode Comparative Example 2.

FIG. 12 shows SEM photographs (a) and (b) of Negative electrode Example 11 and Negative electrode Comparative Example 3.

FIG. 13 shows XRD analysis results of Negative electrode Examples 8 to 11.

FIG. 14 shows dielectric constant and dielectric loss measurement results for Negative electrode Examples 8 to 11 and Negative electrode Comparative Example 3.

FIG. 15 shows V_{OC} and I_{SC} measurement results of a triboelectric nanogenerator having a combination of Positive electrode Examples 1 to 4, Positive electrode Comparative Example 1, Negative electrode Comparative Example 1, and Negative electrode Examples 1 to 3.

FIG. 16 shows an electrical properties measurement result according to a load in a triboelectric nanogenerator having a combination of Positive electrode Example 2 and Negative electrode Example 3.

FIG. 17 shows V_{OC}, I_{SC}, and Q measurement results of a triboelectric nanogenerator having a combination of Positive electrode Examples 1 to 3, Positive electrode Comparative Example 1, Negative electrode Examples 5 to 7, and Negative electrode Comparative Example 2.

FIG. 18 shows an electrical properties measurement result according to a load in a triboelectric nanogenerator having a combination of Positive electrode Example 2 and Negative electrode Example 5.

FIG. 19 shows V_{OC} and I_{SC} measurement results of a triboelectric nanogenerator having a combination of Positive electrode Example 2, Negative electrode Examples 8 to 11, and Negative electrode Comparative Example 3.

FIG. 20 shows an electrical properties measurement result according to a load in a triboelectric nanogenerator having a combination of Positive electrode Example 2 and Negative electrode Example 11.

FIG. 21 is a structural formula of reduced graphene oxide-tetraethylenepentamine.

### DETAILED DESCRIPTION OF THE INVENTION

Hereinafter, preferred embodiments of the present invention will be described as follows with reference to the accompanying drawings. However, embodiments of the present invention may be modified into various other forms, and the scope of the present invention is not limited to the embodiments described below. In addition, the embodiments of the present invention are provided in order to more fully describe the present disclosure to those with average knowledge in the art.

### Triboelectric Platform Composition for Triboelectric Nanogenerator

A tribo-positive electrode composition for a triboelectric nanogenerator according to an embodiment of the present invention includes reduced graphene oxide-tetraethylenepentamine (rGO-TEPA), and a first polymer.

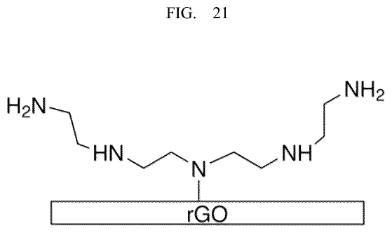

The reduced graphene oxide-tetraethylenepentamine is a material that easily draws electrons to the surroundings or easily emits electrons, and in the present invention, may perform the function of easily emitting electrons by contacting a negative electrode triboelectric material. The reduced graphene oxide-tetraethylenepentamine may be represented by the structural formula of FIG. 21.

In one embodiment, the content of the reduced graphene oxide-tetraethylenepentamine may be 1 part by weight to 10 parts by weight based on 100 parts by weight of the first polymer. If the content is too low or too high, the power generation efficiency may decrease.

The first polymer allows a positive electrode triboelectric material to be formed into a certain shape so as to be utilized as a tribo-positive electrode layer, and allows the reduced graphene oxide-tetraethylenepentamine to be evenly dispersed so as to have high current density.

The first polymer may be a variety of polymer resins cured by a curing agent, and preferably, the polymer resin may be polyurethane (PU).

The tribo-positive electrode composition for a triboelectric nanogenerator may be cured and dried to be prepared into a film-shaped triboelectric layer, which may be placed on an electrode to be used as a triboelectric nanogenerator.

A method for preparing a triboelectric layer for a triboelectric nanogenerator according to an embodiment of the present invention includes preparing a mixture by mixing reduced graphene oxide-tetraethylenepentamine (rGO-TEPA), a first polymer, and a solvent, and molding the mixture into a sheet shape. Next, the method may further include placing the triboelectric layer prepared in the above-described manner on an electrode.

In the step of preparing a mixture by mixing reduced graphene oxide-tetraethylenepentamine, a first polymer, and a solvent, the reduced graphene oxide-tetraethylenepentamine and the first polymer are the same as described above. In the present step, the content of the reduced graphene oxide-tetraethylenepentamine may be 1 part by weight to 10 parts by weight based on 100 parts by weight of the first polymer.

The solvent is not particularly limited as long as it can dissolve the first polymer. The solvent may be an organic solvent, and preferably, may be N, N-dimethylformamide (DMF) or tetrahydrofuran (THF).

In the present step, the mixture may be stirred in a stirrer while being heated. In this case, the temperature of the mixture may be 50° C. to 70° C., and the stirring may be performed for 5 hours to 10 hours.

The step of molding the mixture into a sheet shape may be performed by electrospinning the mixture. Since the electrospinning method is used in one embodiment to allow electrical properties of the reduced graphene oxide-tetraethylenepentamine to be well exhibited, power generation efficiency may be increased by generating power in response to a low pressure.

A sheet prepared in the present step may have a thickness of tens of μm.

The preparation of the triboelectric layer has been completed through the above-described process. Next, the step of placing the triboelectric layer on an electrode may be further performed. The electrode is a conductive material and may be made of a metal or an alloy. In the present step, an additive may be used to bond the triboelectric layer and the electrode, or pressure or heat may be applied to bond the same.

In another embodiment, in a step of molding the mixture into a film shape, the above-described step may be omitted by casting the mixture on an electrode.

A triboelectric layer thus prepared may be used as a tribo-negative electrode layer or a tribo-positive electrode layer, and preferably, may be used as a tribo-positive electrode layer.

### Tribo-Negative Electrode Composition for Triboelectric Nanogenerator

A tribo-negative electrode composition for a triboelectric nanogenerator according to an embodiment of the present invention includes any one among fluorine-functionalized graphite, a perovskite material, and molybdenum sulfide (MoS₂), and a second polymer.

The present invention may include any one among the fluorine-functionalized graphite, the perovskite material, and the molybdenum sulfide (MoS₂), so that each of these will be described below.

Hereinafter, a tribo-negative electrode composition for a triboelectric nanogenerator including fluorine-functionalized graphite will be described.

The fluorine-functionalized graphite is a material that easily draws electrons to the surroundings or easily emits electrons, and in the present invention, may perform the function of easily drawing electrons by contacting a positive electrode triboelectric material. The fluorine-functionalized graphite may be represented by Formula 1 below. Here, it is preferable that x is 1.1 in order to increase electron collection efficiency.

(CFₓ)ₙ [Formula 1]
(Here, X is 0.5 to 1.5, and n is a natural number)

In one embodiment, the content of the fluorine-functionalized graphite may be 5 parts by weight to 17 parts by weight, preferably 13 parts by weight to 17 parts by weight, based on 100 parts by weight of the second polymer. If the content of the fluorine-functionalized graphite is too high, there is a problem in that a film cannot be formed since curing is not achieved, and if the content is too low, there is a problem in that power density is low and impedance increases.

The second polymer allows a negative electrode triboelectric material to be formed into a certain shape so as to be utilized as a film-shaped triboelectric layer, and allows the fluorine-functionalized graphite to be evenly dispersed so as to have high current density.

The second polymer may be a variety of polymer resins cured by a curing agent, and preferably, the polymer resin may be silicone rubber. Compared to other polymer materials, silicone rubber has excellent tensile strength and abrasion resistance, is chemically stable, and has excellent processability. The silicone rubber may be polydimethylsiloxane (PDMS) or a PDMS containing a platinum catalyst. The PDMS containing a platinum catalyst may be Ecoflex™ of Smooth-On Inc. By specifying the second polymer as described above, even if the content of the fluorine-functionalized graphite is high, it is possible to achieve curing to maintain a certain shape.

Hereinafter, a tribo-negative electrode composition for a triboelectric nanogenerator including a perovskite material will be described.

The perovskite material is a material that easily draws electrons to the surroundings or easily emits electrons, and in the present invention, may perform the function of easily drawing electrons by contacting a positive electrode triboelectric material. The perovskite material is barium strontium titanate, and may be represented by Formula 2.

BaₓSr-xTiO₃ [Formula 2]
(x is a natural number)

In one embodiment, the content of the perovskite material may be 5 parts by weight to 10 parts by weight, preferably 5 parts by weight to 8 parts by weight, based on 100 parts by weight of the second polymer. If the content of the perovskite material is too high or too low, there is a problem in that power density is low and impedance increases.

The second polymer allows a negative electrode triboelectric material to be formed into a certain shape so as to be utilized as an electrode part, and allows the perovskite material to be evenly dispersed so as to have high current density.

The second polymer may be a variety of polymer resins cured by a curing agent, and preferably, the polymer resin may be silicone rubber. Compared to other polymer materials, silicone rubber has excellent tensile strength and abrasion resistance, is chemically stable, and has excellent processability. The silicone rubber may be polydimethylsiloxane (PDMS) or a PDMS containing a platinum catalyst. The PDMS containing a platinum catalyst may be Ecoflex™ of Smooth-On Inc. By specifying the second polymer as described above, even if the content of the fluorocarbon is high, it is possible to achieve curing to maintain a certain shape.

Hereinafter, a tribo-negative electrode composition for a triboelectric nanogenerator including molybdenum sulfide (MoS₂) of will be described.

The molybdenum sulfide (MoS₂) is a material that easily draws electrons to the surroundings or easily emits electrons, and in the present invention, may perform the function of easily drawing electrons by contacting a positive electrode triboelectric material.

In one embodiment, the content of the molybdenum sulfide may be 0.2 parts by weight to 2.0 parts by weight, preferably 1 part by weight to 1.5 parts by weight, based on 100 parts by weight of the second polymer. If the content is too high, there is a problem in that curing is not achieved, and if the content is too low, there is a problem in that power generation efficiency decreases.

In one embodiment, the average particle diameter of the molybdenum sulfide may be 50 nm to 100 nm. If the average particle diameter is out of the corresponding particle diameter, it will be difficult to achieve dispersion, so that power generation efficiency may decrease.

The second polymer allows a negative electrode triboelectric material to be formed into a certain shape so as to be utilized as a triboelectric layer, and allows the molybdenum sulfide to be evenly dispersed so as to have high current density.

The second polymer may be a variety of polymer resins cured by a curing agent, and preferably, the polymer resin may be silicone rubber. Compared to other polymer materials, silicone rubber has excellent tensile strength and abrasion resistance, is chemically stable, and has excellent processability. The silicone rubber may be polydimethylsiloxane (PDMS) or a PDMS containing a platinum catalyst. The PDMS containing a platinum catalyst may be Ecoflex™ of Smooth-On Inc. By specifying the second polymer as described above, even if the content of the molybdenum sulfide is high, it is possible to achieve curing to maintain a certain shape.

The tribo-negative electrode composition for a triboelectric nanogenerator may be cured and dried to be prepared into a film-shaped triboelectric layer, which may be placed on an electrode to be used as a triboelectric nanogenerator.

A method for preparing a triboelectric part for a triboelectric nanogenerator according to an embodiment of the present invention includes preparing a mixture by mixing any one among fluorine-functionalized graphite, a perovskite material, and molybdenum sulfide (MoS₂) with a second polymer, molding the mixture into a film shape, and drying the mixture molded into a film shape. Next, the method may further include placing the triboelectric part prepared in the above-described manner on a current collector.

In the step of preparing a mixture by mixing any one among fluorine-functionalized graphite, a perovskite material, and molybdenum sulfide (MoS₂) with a second polymer, the fluorine-functionalized graphite, the perovskite material, and the molybdenum sulfide (MoS₂), and the second polymer may be the same as those described above.

The step of molding the mixture into a film shape may be performed by a typical method for preparing a film by using a polymer resin. In one embodiment, the mixture may be prepared into a film shape by a melt-casting method. In the present step, a doctor blade or the like may be used to adjust the thickness of a film.

Next, a step of drying the mixture molded into a film shape is performed. The present step may be performed by leaving the mixture to stand at room temperature (20° C. to 30° C.) for 20 hours to 30 hours. The thickness of the dried triboelectric layer (film) may be 200 μm to 250 μm. If necessary, the triboelectric layer may be cut to a certain size.

The preparation of the triboelectric layer has been completed through the above-described process. The step of placing the triboelectric layer on an electrode may be further performed. The electrode is a conductive material and may be made of a metal or an alloy. In the present step, an additive may be used to bond the triboelectric layer and the electrode, or pressure or heat may be applied to bond the same.

In another embodiment, in a step of molding the mixture into a film shape, the above-described step may be omitted by casting the mixture on an electrode.

A triboelectric layer thus prepared may be used as a positive electrode layer or a negative electrode layer, and preferably, may be used as a negative electrode layer.

### Triboelectric Nanogenerator

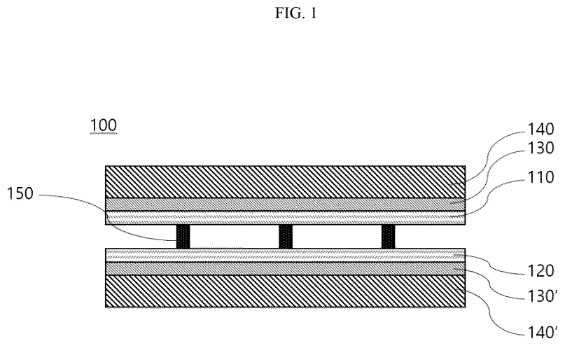

FIG. 1 is a conceptual diagram of a triboelectric nanogenerator 100 according to an embodiment of the present invention. Referring to FIG. 1, the triboelectric nanogenerator according to an embodiment of the present invention includes a tribo-positive electrode layer 120 and a tribo-negative electrode layer 110. In addition, the triboelectric nanogenerator may include an electrode 130′ placed on the tribo-positive electrode layer 120 and an electrode 130 placed on the tribo-negative electrode layer 110. In addition, the triboelectric nanogenerator may further include support plates 140 and 140′ respectively placed on the other side of the electrodes 130 and 130′ to protect the same. The tribo-positive electrode layer 120 and the tribo-negative electrode layer 110 may be electrically connected to allow electrons to move from one to the other, and may be directly or indirectly connected to each other to this end. One embodiment may further include a spacer 150 placed between the tribo-positive electrode layer 120 and the tribo-negative electrode layer 110. Through this, the tribo-positive electrode layer 120 and the tribo-negative electrode layer 110 may be configured to be placed spaced apart from each other at regular intervals at normal times and to come into contact with each other when pressure is applied from the outside.

At least one of the tribo-positive electrode layer and the tribo-negative electrode layer includes the tribo-positive electrode composition or tribo-negative electrode composition described above. Preferably, the tribo-positive electrode layer may include reduced graphene oxide-tetraethylenepentamine (rGO-TEPA) and a first polymer. In addition, preferably, the tribo-negative electrode layer may include any one among fluorine-functionalized graphite, a perovskite material, and molybdenum sulfide (MoS₂), and a second polymer.

The triboelectric nanogenerator may include other components commonly used in the corresponding field, and is not particularly limited.

### Example: Preparation of Tribo-Positive Electrode Layer

Positive electrode Example 1 (PUAFG01): Selectophore™ by Sigma-Aldrich Co. was prepared as polyurethane, and reduced graphene oxide-tetraethylenepentamine by Sigma-Aldrich Co. was prepared as reduced graphene oxide-tetraethylenepentamine. N,N-dimethylformamide (DMF, 99.8%) by Acros Organics Co. was prepared as a solvent, and tetrahydrofuran (THF>purity 99%) by Daejung Chemical Industry Co., Ltd was prepared as tetrahydrofuran. 1 g of the polyurethane and 0.01 g of the reduced graphene oxide-tetraethylenepentamine were added to 9 g of a solvent in which DMF and THF were mixed at a volume ratio of 4:6, and stirred at 60° C. and 500 rpm for 8 hours. Using an electrospinning machine, the mixture was electrospun under the conditions of a voltage of 10 kV, a distance of 12 cm from a tip to a collector, a discharge rate of 1 mL/h, a collector rate of 100 rpm, a temperature of 10° C. to 12° C., and a relative humidity 40% to 50% to be prepared in the shape of a sheet. The electrospun sheet was prepared on a current collector (collector) wrapped in aluminum foil. The mixture in the shape of a sheet was placed in an oven and dried at 80° C. for 10 hours. Through this, a tribo-positive electrode layer including 1 part by weight of reduced graphene oxide-tetraethylenepentamine based on 100 parts by weight of polyurethane was prepared. The thickness of the tribo-positive electrode layer thus prepared was 30−40±2 μm.

Positive electrode Example 2 (PUAFG02): A tribo-positive electrode layer was prepared in the same manner as in Positive electrode Example 1, except that 0.02 g of reduced graphene oxide-tetraethylenepentamine was added to prepare a tribo-positive electrode layer including 2 parts by weight of reduced graphene oxide-tetraethylenepentamine based on 100 parts by weight of polyurethane.

Positive electrode Example 3 (PUAFG05): A tribo-positive electrode layer was prepared in the same manner as in Positive electrode Example 1, except that 0.05 g of reduced graphene oxide-tetraethylenepentamine was added to prepare a tribo-positive electrode layer including 5 parts by weight of reduced graphene oxide-tetraethylenepentamine based on 100 parts by weight of polyurethane.

Positive electrode Example 4 (PUAFG010): A tribo-positive electrode layer was prepared in the same manner as in Positive electrode Example 1, except that 0.10 g of reduced graphene oxide-tetraethylenepentamine was added to prepare a tribo-positive electrode layer including 10 parts by weight of reduced graphene oxide-tetraethylenepentamine based on 100 parts by weight of polyurethane.

Positive electrode Comparative Example 1 (PU): A tribo-positive electrode layer was prepared in the same manner as in Positive electrode Example 1, except that reduced graphene oxide-tetraethylenepentamine was not added.

### Example: Preparation of Tribo-Negative Electrode Layer (Fluorine-Functionalized Graphite)

Negative electrode Example 1 (EC5FG): Fluorine-functionalized graphite by Sigma-Aldrich Co. was prepared as fluorine-functionalized graphite, and Ecoflex™-00-30 by Smooth-On Co. was prepared as silicone rubber. 0.5 g of fluorine-functionalized graphite was mixed with 10 g of silicone rubber in which member A and member B were mixed and sufficiently stirred to prepare a mixture. Next, the mixture was poured onto sandpaper and the thickness thereof was adjusted to 235±5 μm using a doctor blade, and then dried at room temperature (20° C. to 25° C.) for 24 hours. Through this, a tribo-negative electrode layer including 5 parts by weight of fluorine-functionalized graphite based on 100 parts by weight of silicon rubber was prepared. The thickness of the prepared tribo-negative electrode layer was 235±5 μm.

Negative electrode Example 2 (EC10FG): A tribo-negative electrode layer was prepared in the same manner as in Negative electrode Example 1, except that 1.0 g of fluorine-functionalized graphite was added to prepare a tribo-negative electrode layer including 10 parts by weight of fluorine-functionalized graphite based on 100 parts by weight of silicone rubber.

Negative electrode Example 3 (EC15FG): A tribo-negative electrode layer was prepared in the same manner as in Negative electrode Example 1, except that 1.5 g of fluorine-functionalized graphite was added to prepare a tribo-negative electrode layer including 15 parts by weight of fluorine-functionalized graphite based on 100 parts by weight of silicone rubber.

Negative electrode Example 4 (EC20FG): A tribo-negative electrode layer was prepared in the same manner as in Negative electrode Example 1, except that 2.0 g of fluorine-functionalized graphite was added to prepare a tribo-negative electrode layer including 20 parts by weight of fluorine-functionalized graphite based on 100 parts by weight of silicone rubber.

Negative electrode Comparative Example (EC): A tribo-negative electrode layer was prepared in the same manner as in Negative electrode Example 1, except that fluorine-functionalized graphite was not added.

### Example: Preparation of Tribo-Negative Electrode Layer (Barium Strontium Titanate)

Negative electrode Example 5 (EC5): Barium strontium titanate powder by Sigma-Aldrich Co. was prepared as barium strontium titanate powder, and Ecoflex™-00-30 by Smooth-On Co. was prepared as silicone rubber. 0.55 g of barium strontium titanate powder was mixed with 10 g of silicone rubber member A member, and then 1 g of silicone rubber member B was added thereto and sufficiently stirred to prepare a mixture. Next, the mixture was poured onto sandpaper and the thickness thereof was adjusted to 30±5 μm using a doctor blade, and then dried at room temperature (20° C. to 25° C.) for 24 hours. Through this, a tribo-negative electrode layer including 5 parts by weight of barium strontium titanate based on 100 parts by weight of silicon rubber was prepared. The thickness of the prepared tribo-negative electrode layer was 20±10 μm.

Negative electrode Example 6 (EC7.5): A tribo-negative electrode layer was prepared in the same manner as in Negative electrode Example 5, except that 0.825 g of barium strontium titanate powder was added to prepare a tribo-negative electrode layer including 7.5 parts by weight of barium strontium titanate based on 100 parts by weight of silicone rubber.

Negative electrode Example 7 (EC10): A tribo-negative electrode layer was prepared in the same manner as in Negative electrode Example 5, except that 1.1 g of barium strontium titanate powder was added to prepare a tribo-negative electrode layer including 10 parts by weight of barium strontium titanate based on 100 parts by weight of silicone rubber.

Negative electrode Comparative Example 2 (EC0): A tribo-negative electrode layer was prepared in the same manner as in Negative electrode Example 5, except that barium strontium titanate powder was not added.

### Example: Preparation of Tribo-Negative Electrode Layer (Molybdenum Sulfide)

Negative electrode Example 8 (EC0.2): Molybdenum sulfide by Sigma-Aldrich Co. (diameter 90 nm) was prepared as molybdenum sulfide, and Ecoflex™-00-30 by Smooth-On Co. was prepared as silicone rubber. P-60 standard sandpaper was prepared to give roughness to the surface of a tribo-negative electrode layer. 0.02 g of molybdenum sulfide was mixed with 10 g of silicone rubber in which member A and member B were mixed and sufficiently stirred to prepare a mixture. Next, the mixture was poured onto sandpaper and the thickness thereof was adjusted to 230±5 μm using a doctor blade, and then dried at room temperature (20° C. to 25° C.) for 8 hours. Through this, a tribo-negative electrode layer including 0.2 parts by weight of molybdenum sulfide based on 100 parts by weight of silicon rubber was prepared.

Negative electrode Example 9 (EC0.5): A tribo-negative electrode layer was prepared in the same manner as in Negative electrode Example 8, except that 0.05 g of molybdenum sulfide was added to prepare a tribo-negative electrode layer including 0.5 parts by weight of molybdenum sulfide based on 100 parts by weight of silicone rubber.

Negative electrode Example 10 (EC1): A tribo-negative electrode layer was prepared in the same manner as in Negative electrode Example 8, except that 0.10 g of molybdenum sulfide was added to prepare a tribo-negative electrode layer including 1.0 parts by weight of molybdenum sulfide based on 100 parts by weight of silicone rubber.

Negative electrode Example 11 (EC1.5): A tribo-negative electrode layer was prepared in the same manner as in Negative electrode Example 8, except that 0.15 g of molybdenum sulfide was added to prepare a tribo-negative electrode layer including 1.5 parts by weight of molybdenum sulfide based on 100 parts by weight of silicone rubber.

Negative electrode Example 12: A tribo-negative electrode layer was prepared in the same manner as in Negative electrode Example 8, except that 0.20 g of molybdenum sulfide was added to prepare a tribo-negative electrode layer including 2.0 parts by weight of molybdenum sulfide based on 100 parts by weight of silicone rubber. The example prepared as described above was not cured.

Negative electrode Comparative Example 3 (EC0): A tribo-negative electrode layer was prepared in the same manner as in Negative electrode Example 8, except that molybdenum sulfide was not added.

### Example: Manufacturing of Triboelectric Nanogenerator

Triboelectric nanogenerators were manufactured by combining Examples and Comparative Examples prepared above. First, the tribo-positive electrode layer of each of Negative electrode Examples and Negative electrode Comparative Examples was cut to 5 cm in width×5 cm in length, and one surface thereof was bonded to one surface of an Al electrode. The tribo-positive electrode layer of each of Positive electrode Examples and Positive electrode Comparative Examples was also cut to 5 cm in width×5 cm in length, and one surface thereof was bonded to one surface of an Al electrode. A spacer having a length of 8 mm was placed between the other surface of the tribo-negative electrode layer and the other surface of the tribo-positive electrode layer, and then each of the other surfaces was placed to face the spacer, and two acrylic plates of 5 cm in width×5 cm in length were respectively attached to the other surfaces of the Al electrodes. The overall shape is as shown in FIG. 1. When pressure was applied to the acrylic plates, the tribo-positive electrode layers and the tribo-negative electrode layers came into contact with each other.

### Experimental Example: Visual Observation

Negative electrode Examples 1 to 4 and Negative electrode Comparative Example 1 were visually observed. Negative electrode Example 4 was not properly cured due to an excessive content of fluorine-functionalized graphite, and thus, could not be utilized as a tribo-negative electrode layer.

### Experimental Example: SEM Analysis

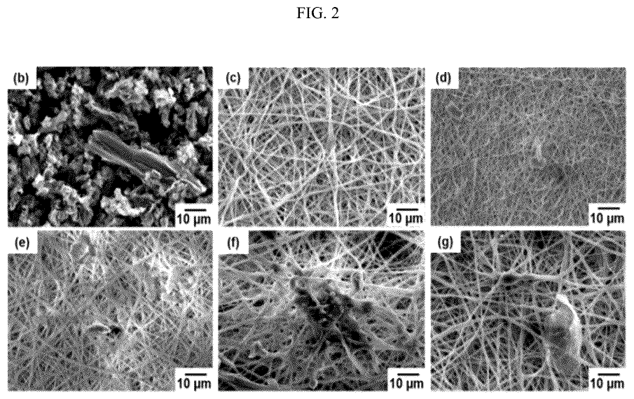

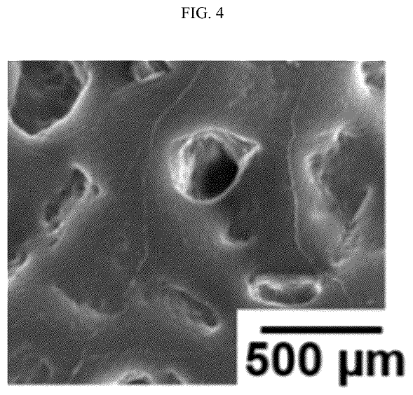

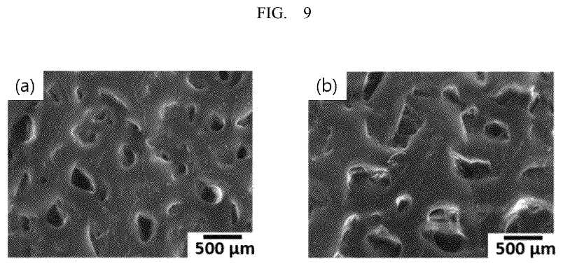

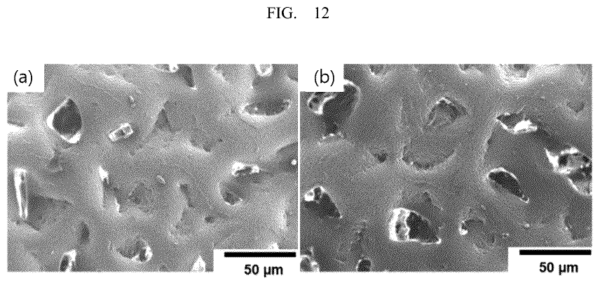

The present analysis was performed under the condition of 15 kV using a scanning electron microscope (SEM, JEOL Ltd. JSM-6510). FIG. 2 shows SEM photographs of reduced graphene oxide-tetraethylenepentamine, Positive electrode Comparative Example 1, and Positive electrode Examples 1 to 4, FIG. 4 is an SEM photograph of Negative electrode Example 3, FIGS. 9(a) and 9(b) are respectively SEM photographs of Negative electrode Examples 5 and 7, and FIGS. 12(a) and 12(b) are respectively SEM photographs of Negative electrode Example 11 and Negative electrode Comparative Example 3.

Referring to FIG. 2, it can be seen that a mass was observed on the surface of each of the Positive electrode Examples 3 (PUAFG05) and 4 PUAFGO10) in which the content of the reduced graphene oxide-tetraethylenepentamine was 5 parts by weight or greater.

### Experimental Example: EDS Analysis

Surface elements of Examples and Comparative Examples were analyzed using an EDS device.

Table 1 shows analysis results of reduced graphene oxide-tetraethylenepentamine, Positive electrode Examples, and Positive electrode Comparative Examples. According to Table 1, it can be seen that a measured value of the N element increases as the content of the reduced graphene oxide-tetraethylenepentamine increases.

TABLE 1

| Classification | C (wt %) | N (wt %) | O (wt %) |
|---|---|---|---|
| rGO-TEPA | 73.6 | 12.4 | 14.0 |
| powder | | | |
| Positive | 76.9 | 2.8 | 20.2 |
| electrode | | | |
| Example 1 | | | |
| Positive | 76.2 | 3.2 | 20.4 |
| electrode | | | |
| Example 2 | | | |
| Positive | 74.2 | 3.3 | 22.4 |
| electrode | | | |
| Example 3 | | | |
| Positive | 75.2 | 3.3 | 24.4 |
| electrode | | | |
| Example 4 | | | |
| Positive | 77.6 | 2.2 | 20.1 |
| electrode | | | |
| Comparative | | | |
| Example 1 | | | |

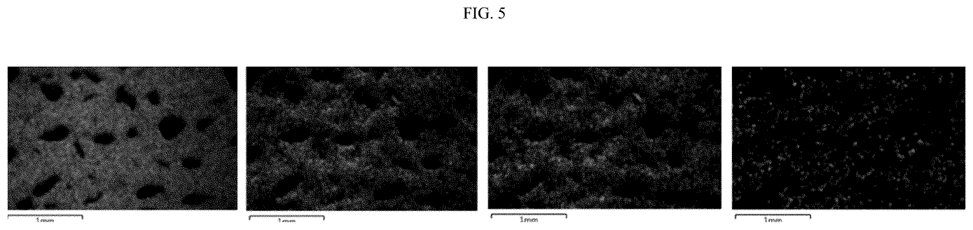

FIG. 5 shows analysis results of Negative electrode Example 3, and Table 2 shows analysis results of fluorine-functionalized graphite and Negative electrode Examples 1 to 4. From FIG. 5 it can be seen that Si, O, C and F elements are observed. In addition, according to Table 2, it can be seen that a measured value of the F element significantly increases as the content of the fluorine-functionalized graphite increases.

TABLE 2

| Classification | C (wt %) | O (wt %) | F (wt %) | Si (wt %) |
|---|---|---|---|---|
| Fluorine- | 62.2 | 6.8 | 31.3 | — |
| functionalized | | | | |
| graphite | | | | |
| Negative | 30.3 | 25.8 | 0.8 | 43.3 |
| electrode | | | | |
| Example 1 | | | | |
| Negative | 31.3 | 24.2 | 1.1 | 43.4 |
| electrode | | | | |
| Example 2 | | | | |
| Negative | 28.3 | 17.8 | 2.1 | 51.8 |
| electrode | | | | |
| Example 3 | | | | |
| Negative | — | 31.9 | — | 68.1 |
| electrode | | | | |
| Example 4 | | | | |

### Experimental Examples: XRD Analysis

The XRD analysis was performed under the conditions of 40 kV and 3 mA using CuK α.

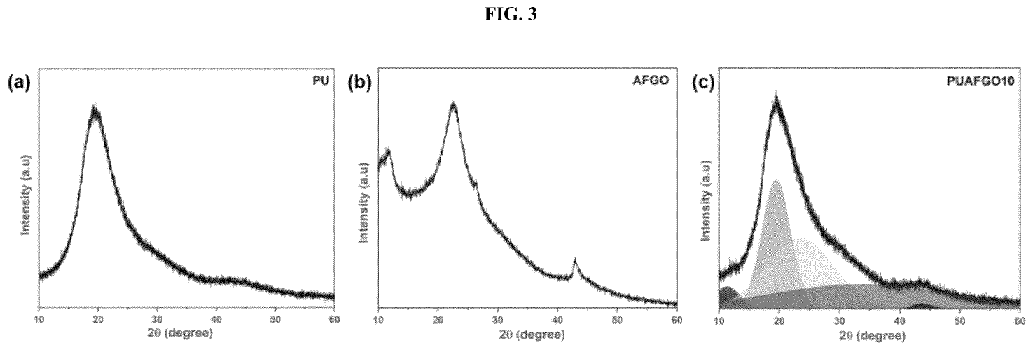

FIGS. 3(a), 3(b), and 3(c) respectively show XRD analysis results of Positive electrode Comparative Example 1, reduced graphene oxide-tetraethylenepentamine, and Positive electrode Example 4. FIG. 3(c) is a representation using Gaussian multi-peak fittings of the Origin software. Referring to FIG. 3, it can be seen that peaks of both the polyurethane and the reduced graphene oxide-tetraethylenepentamine are observed in Positive electrode Example 4.

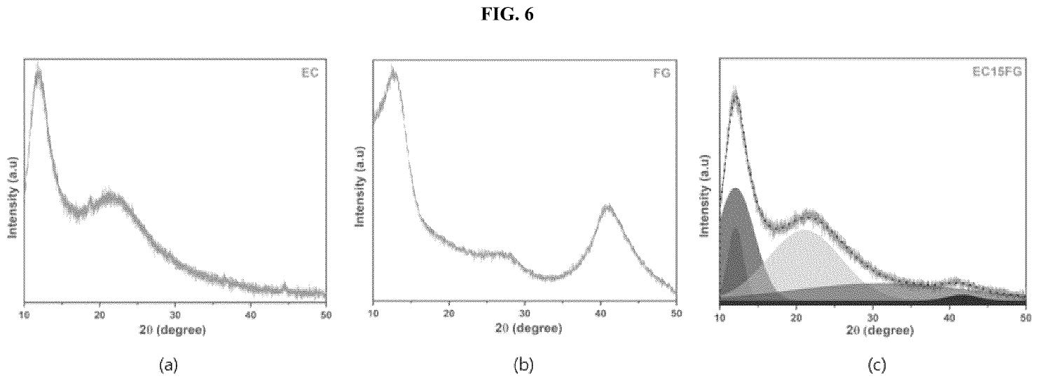

FIGS. 6(a), 6(b), and 6(c) respectively show XRD analysis results of silicone rubber (Ecoflex™-00-30), fluorine-functionalized graphite, and Negative electrode Example 3. FIG. 6(c) is a representation using Gaussian multi-peak fittings of the Origin software. Referring to FIG. 6, it can be seen that peaks of both the polyurethane and the fluorine-functionalized graphite are observed in Negative electrode Example 3.

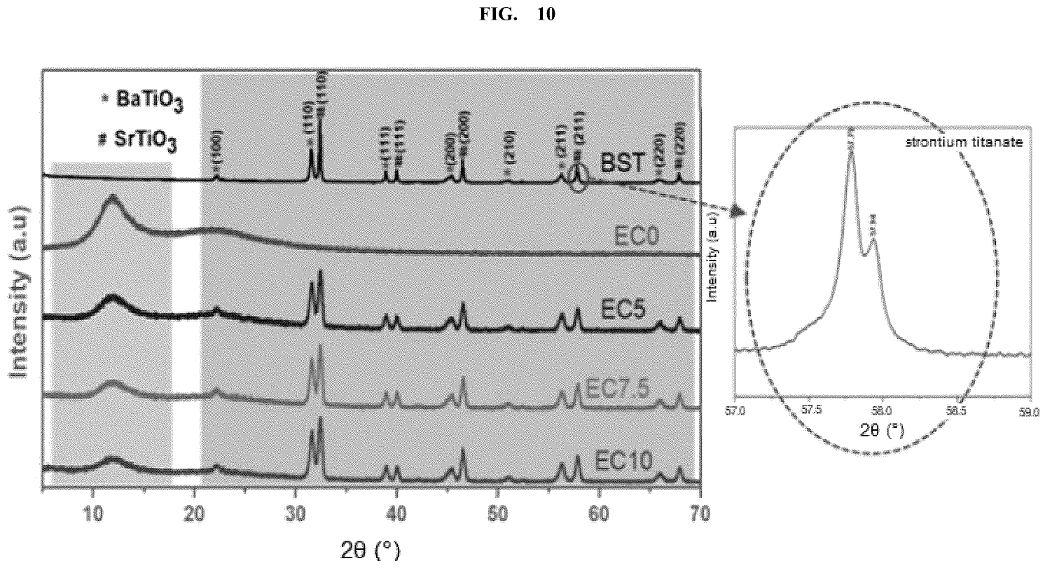

FIG. 10 shows XRD analysis results of Negative electrode Examples 5 to 7 and Negative electrode Comparative Example 2. Referring to FIG. 10, it can be seen that a characteristic peak of barium strontium titanate is observed in Negative electrode Examples 5 to 7.

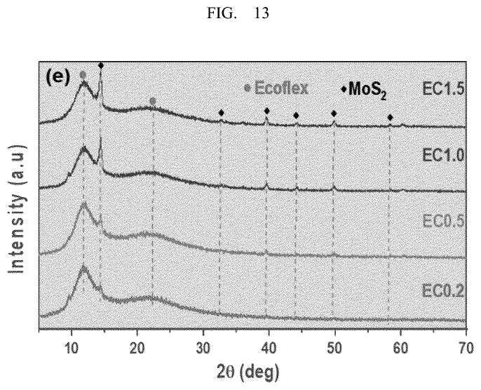

FIG. 13 shows XRD analysis results of Negative electrode Examples 8 to 11. Referring to FIG. 13, it can be seen that a characteristic peak of molybdenum sulfide is observed in Negative electrode Examples 8 to 11.

### Experimental Example: Measurement of Dielectric Constant and Dielectric Loss

The dielectric constant and dielectric loss were measured using impedance/gain phase analyzer (SI-1260, Solartron Analytical Co., UK) under the conditions of 25° C. and a relative humidity of 41%.

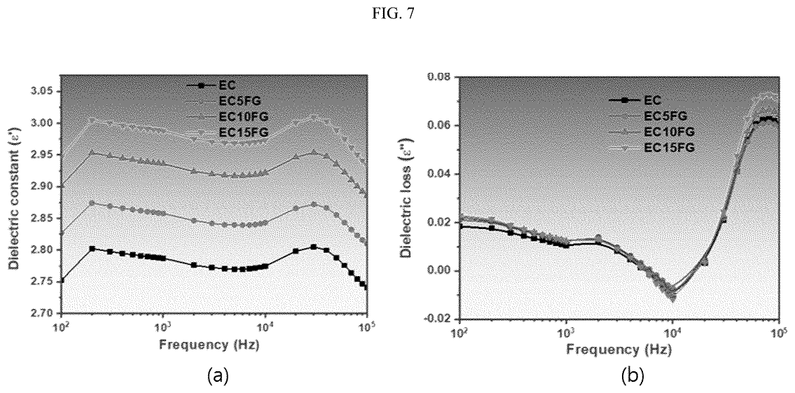

FIGS. 7(a) and 7(b) respectively show dielectric constant and dielectric loss measurement results for Negative electrode Examples 1 to 3 and Negative electrode Comparative Example 1. Referring to FIG. 7, it can be seen that the higher the content of the fluorine-functionalized graphite, the higher the dielectric constant, but the change in dielectric loss is not significant. That is, it has been proven that in Negative electrode Example 3 in which the content of the fluorine-functionalized graphite is 15 parts by weight, the dielectric constant may improve without affecting the dielectric loss.

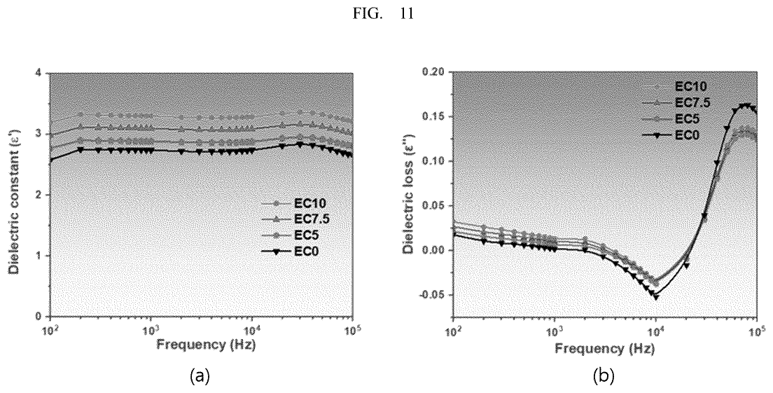

FIGS. 11(a) and 11(b) respectively show dielectric constant and dielectric loss measurement results for Negative electrode Examples 5 to 7 and Negative electrode Comparative Example 2. Referring to FIG. 11, it can be seen that the higher the content of barium strontium titanate, the higher the dielectric constant, but the change in dielectric loss is not significant. Through this, it can be seen that the dielectric constant may improve without affecting the dielectric loss by adding barium strontium titanate.

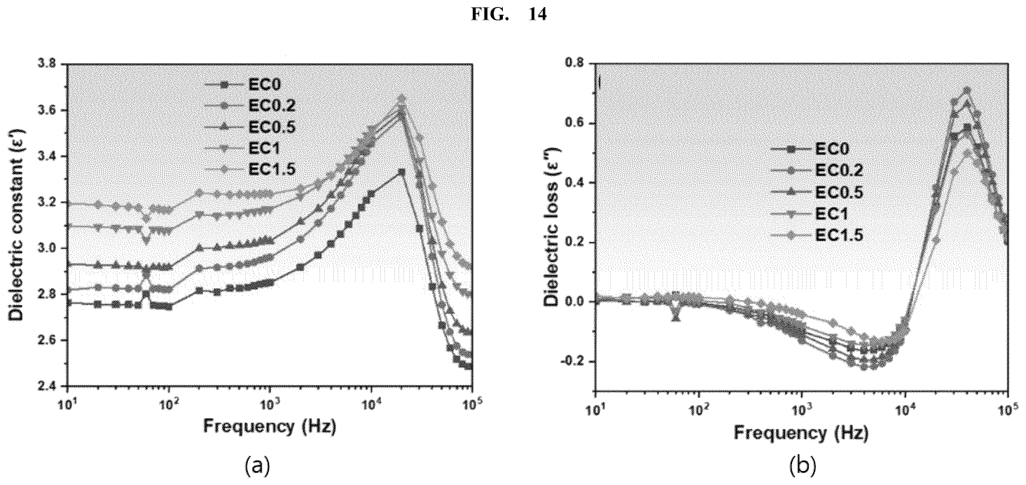

FIGS. 14(a) and 14(b) respectively show dielectric constant and dielectric loss measurement results for Negative electrode Examples 8 to 11 and Negative electrode Comparative Example 3. Referring to FIG. 14, it can be seen that the higher the content of molybdenum sulfide, the higher the dielectric constant, but the change in dielectric loss is not significant. Through this, it can be seen that the dielectric constant may improve without affecting the dielectric loss by adding molybdenum sulfide.

### Experimental Example: Measurement of Surface Potential

The surface potential was measured in a non-contact mode using a Kelvin probe force microscope (KPFM; NX10, Park Systems).

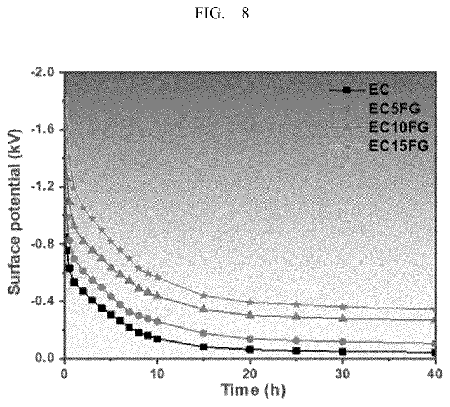

FIG. 8 shows surface potential measurement results over time for Negative electrode Examples 1 to 3 and Negative electrode Comparative Example 1. Referring to FIG. 8, it can be seen that the surface potential decreased significantly up to the first 10 hours, and then converged constantly. After 40 hours, the surface potential decreases by 19 times from −848 V to −43 V in Negative electrode Example 4, but the surface potential decreases by 5 times from −1813 V to −346 in Negative electrode Example 3, so that it can be seen that Negative electrode Example 3 has better performance.

### Experimental Example: Measurement of Electrical Properties of Triboelectric Nanogenerator

V_{OC} and I_{SC} were measured using the triboelectric nanogenerators manufactured by combining the tribo-negative electrode layers and the tribo-positive electrode layers prepared above. To this end, an oscilloscope (TBS2204B, Tektronix), a low-noise amplifier (DLPCA-200, Femto), and an electrometer (6514, Keithley) were used.

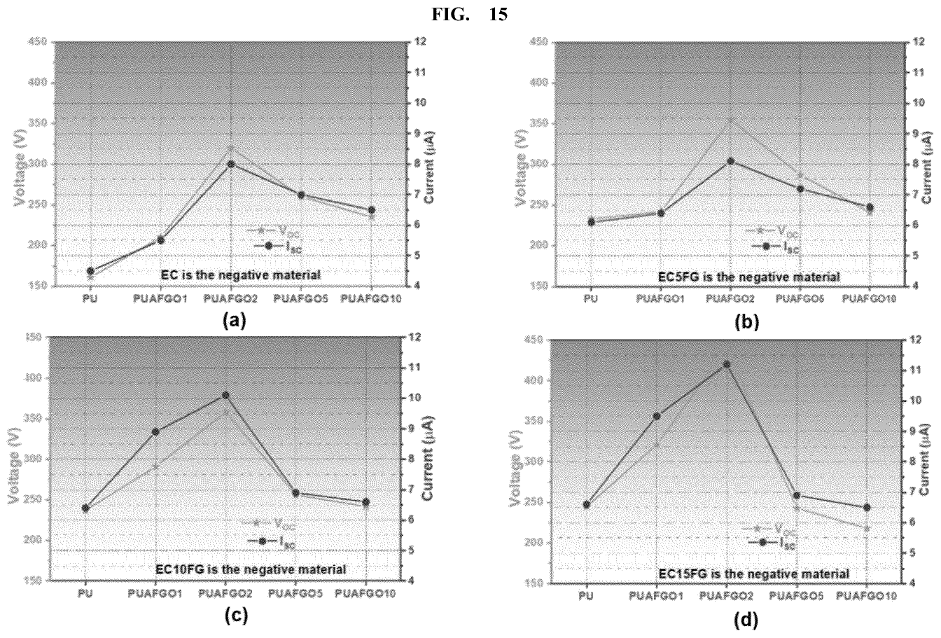

FIG. 15(a) illustrates measurement values of a triboelectric nanogenerator having a combination of Negative electrode Comparative Example 1, Positive electrode Examples 1 to 4, and Positive electrode Comparative Example 1, FIG. 15(b) illustrates measurement values of a triboelectric nanogenerator having a combination of Negative electrode Example 1, Positive electrode Examples 1 to 4, and Positive electrode Comparative Example 1, FIG. 15(c) illustrates measurement values of a triboelectric nanogenerator having a combination of Negative electrode Example 2, Positive electrode Examples 1 to 4, and Positive electrode Comparative Example 1, and FIG. 15(d) illustrates measurement values of a triboelectric nanogenerator having a combination of Negative electrode Example 3, Positive electrode Examples 1 to 4, and Positive electrode Comparative Example 1. Referring to FIG. 15, it can be seen that Positive electrode Example 2, in which the content of the reduced graphene oxide-tetraethylenepentamine is 2 parts by weight, exhibits the best electrical properties, and if the content deviates from the above content, the electrical properties are reduced.

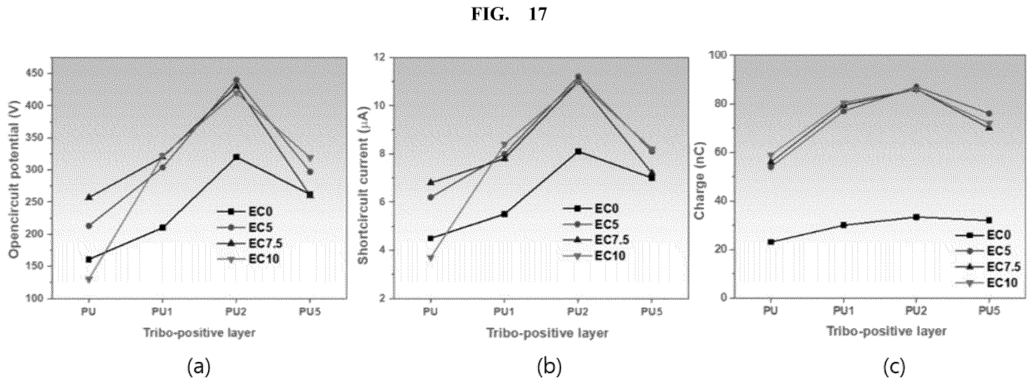

FIGS. 17(a) to 17(c) respectively show V_{OC}, I_{SC}, and Q measurement results of a triboelectric nanogenerator having a combination of Positive electrode Examples 1 to 3, Positive electrode Comparative Example 1, Negative electrode Examples 5 to 7, and Negative electrode Comparative Example 2. Referring to FIG. 17(a), in a combination with Positive electrode Example 2, V_{OC} increased from 161 V to 257 V while the content of barium strontium titanate increased from 0 part by weight to 7.5 parts by weight, but decreased to 130 V when the content thereof was 10 parts by weight, which exceeded 7.5 parts by weight. In addition, such a trend was also similarly observed in I_{SC} (see FIG. 17(b)). Through this, it can be seen that when the content of barium strontium titanate deviates from a specific value, the current density decreases.

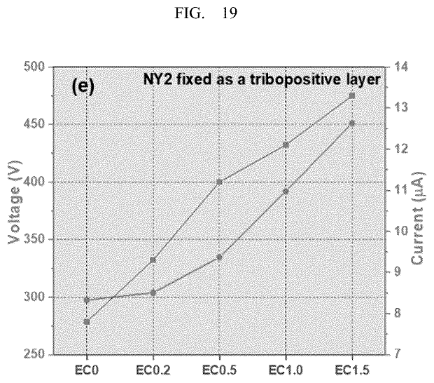

FIG. 19 shows V_{OC} and I_{SC} measurement results of a triboelectric nanogenerator having a combination of Positive electrode Example 2, Negative electrode Examples 8 to 11, and Negative electrode Comparative Example 3. Referring to FIG. 19, in a combination with Positive electrode Example 2, V_{OC} increased from 297.4 V to 451 V while the content of molybdenum sulfide increased from 0 part by weight to 1.5 parts by weight, and I_{SC} also increased as the content of molybdenum sulfide increased. Particularly, high values were seen in Negative electrode Examples 10 and 11 in which the content of the molybdenum sulfide was 1.0 part by weight or greater.

### Experimental Example: Measurement of Electrical Properties of Triboelectric Nanogenerator According to Load Pressure

Changes in V_{OC} and I_{SC} were measured when a load of 0.3 N to 10 N was applied to a triboelectric nanogenerator.

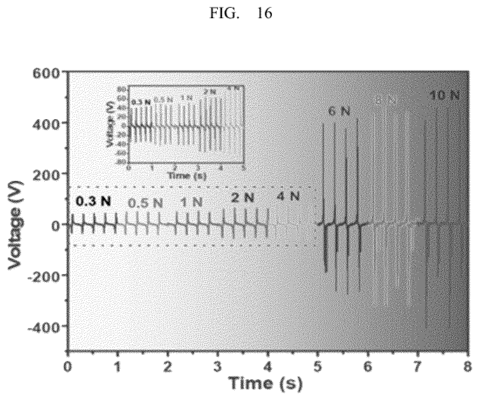

FIG. 16 shows an electrical properties measurement result according to a load in a triboelectric nanogenerator having a combination of Positive electrode Example 2 and Negative electrode Example 3. Referring to FIG. 16, it can be seen that the output improves according to a load, and high output is exhibited at a pressure of 6 N or greater in particular.

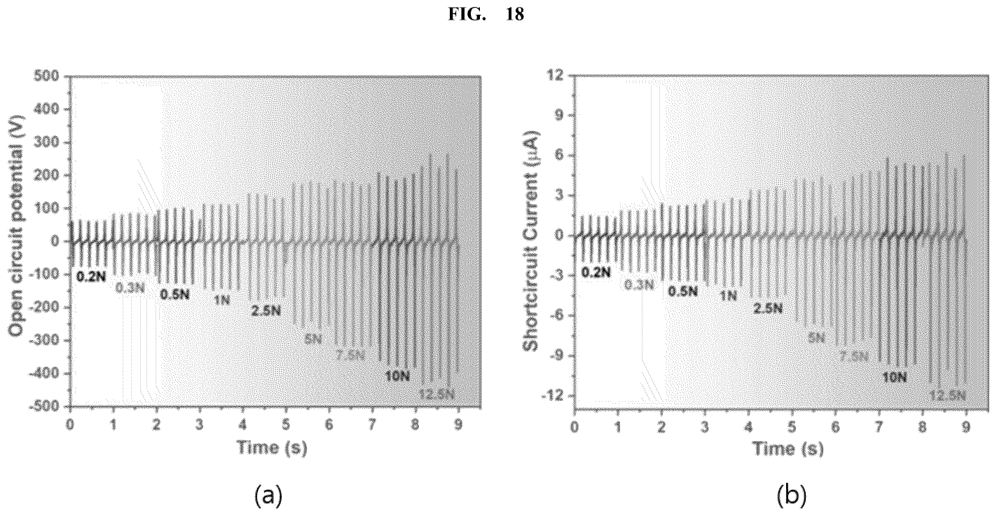

FIG. 18 shows an electrical properties measurement result according to a load in a triboelectric nanogenerator having a combination of Positive electrode Example 2 and Negative electrode Example 5. Referring to FIG. 18, it can be seen that the output improves according to a load.

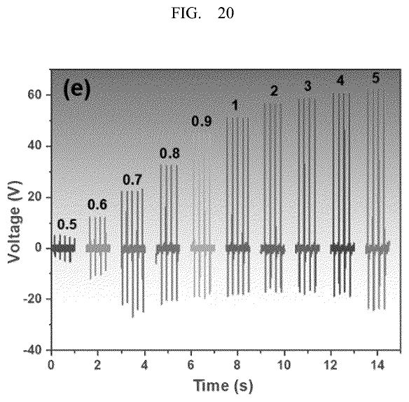

FIG. 20 shows an electrical properties measurement result according to a load in a triboelectric nanogenerator having a combination of Positive electrode Example 2 and Negative electrode Example 11. Referring to FIG. 20, it can be seen that the output improves according to a load.

1. A tribo-positive electrode composition for a triboelectric nanogenerator, the compositing comprising reduced graphene oxide-tetraethylenepentamine (rGO-TEPA), and a first polymer.

2. The tribo-positive electrode composition of claim 1, wherein the content of the reduced graphene oxide-tetraethylenepentamine is 1 part by weight to 10 parts by weight based on 100 parts by weight of the first polymer.

3. A tribo-negative electrode composition for a triboelectric nanogenerator, the compositing comprising any one among fluorine-functionalized graphite, a perovskite material, and molybdenum sulfide (MoS₂), and a second polymer.

4. The tribo-negative electrode composition of claim 3, wherein:
the content of the fluorine-functionalized graphite is 5 parts by weight to 15 parts by weight based on 100 parts by weight of the second polymer;
the content of the perovskite material is 5 parts by weight to 10 parts by weight based on 100 parts by weight of the second polymer; and
the content of the molybdenum sulfide is 0.2 parts by weight to 2.0 parts by weight based on 100 parts by weight of the second polymer.

5. The tribo-negative electrode composition of claim 3, wherein the perovskite material is barium strontium titanate.

6. A triboelectric nanogenerator comprising a tribo-positive electrode layer, and a tribo-negative electrode layer,
wherein:
the tribo-positive electrode layer includes reduced graphene oxide-tetraethylenepentamine (rGO-TEPA) and a first polymer; and
the tribo-negative electrode layer includes any one among fluorine-functionalized graphite, a perovskite material, and molybdenum sulfide (MoS₂), and a second polymer.

7. The triboelectric nanogenerator of claim 6, wherein the tribo-positive electrode layer is prepared by an electrospinning method using a first mixture in which the reduced graphene oxide-tetraethylenepentamine, and the first polymer are mixed.

8. The triboelectric nanogenerator of claim 6, wherein the tribo-negative electrode layer is prepared by a casting method using a second mixture in which any one among the fluorine-functionalized graphite, the perovskite material, and the molybdenum sulfide (MoS₂), and the second polymer are mixed.
